(19) United States
(12) Patent Application Publication
(10) Pub. No.: US 2004/0016700 A1
(43) Pub. Date: Jan. 29, 2004

(54) System and a method for determining integrity of a dialyzer

(76) Inventors: Benjamin Kellam, Clearwater, FL (US); Robert Childers, New Port Richey, FL (US)

Correspondence Address: BAXTER HEALTHCARE CORPORATION, RENAL DIVISION, 1 BAXTER PARKWAY, DF3-3E, DEERFIELD, IL, 60015, US

(21) Appl. No.: 10/200,995

(22) Filed: Jul. 23, 2002

(51) Int. Cl. B01D 61/32

(52) U.S. Cl. 210/646; 210/90; 210/321.89; 210/500.23; 73/38; 73/40

(57) ABSTRACT

A system and a method for determining integrity of a dialyzer are provided. The dialyzer may have a gas, such as, for example, air, within the dialyzer. A liquid chamber may be connected to the dialyzer. Liquid within the liquid chamber may be directed toward the dialyzer. The air within the dialyzer may then be compressed. A monitor may be provided exterior to the dialyzer to measure a pressure decay within the dialyzer as the compressed air exits the dialyzer. A comparison between the pressure decay and a leak threshold associated with the dialyzer may assist in determining whether the dialyzer has a leak wherein the dialyzer is unacceptable for use.

### BACKGROUND OF THE INVENTION

The present invention relates to a system and a method for determining integrity of a dialyzer. Preferably, the integrity of the dialyzer is determined before priming of the dialyzer. The system and method measure the amount of a gas that may pass through a dialyzer after transmittal of a liquid towards the dialyzer. A high level of gas passing through the dialyzer indicates that the integrity of the dialyzer has been compromised and the dialyzer is not fit for use.

It is generally known to introduce fluids into the body, including medicaments and supplements, as well as bodily fluids, such as blood, plasma or the like. Often, a fluid delivery system is used to introduce these materials. An example of a fluid delivery system may be a dialysis system. A dialyzer may be implemented within the dialysis system to purify blood or other fluids.

A dialyzer may have a tube having an inlet dialysate port and an outlet dialysate port. A fluid for purifying blood, such as, for example, dialysate, may enter the dialyzer through the inlet dialysate port. The dialysate may exit the dialyzer from the outlet dialysate port. The dialyzer may also contain hollow fibers having a tube-like shape. The hollow fibers house fluids such as blood, plasma or the like. Fluids within the hollow fibers are separated from the dialysate exterior to the hollow fibers. The dialysate may contain elements which may potentially contaminate blood. Therefore, contact between the dialysate and the blood within the hollow fibers should be avoided. Thus, for efficient dialysis to occur, the hollow fibers of the dialyzer must be devoid of leaks and/or damage.

Integrity of a dialyzer refers to structural ability of the hollow fibers of the dialyzer to hold blood or other fluids. The integrity of the dialyzer is determined by the amount of fluid that passes through the dialyzer fiber walls when fluid under pressure passes through the dialyzer. If the dialyzer passes more than a certain amount of fluid pumped against the dialyzer from passing though the dialyzer, the integrity of the dialyzer is not acceptable.

Testing of the integrity of a dialyzer may be conducted at a dialyzer manufacturing plant during a manufacturing process. A second test may occur after an operator or patient places the dialyzer into a dialysis device. Often, the second test is not performed because operator and/or patient interaction with the dialyzer is required. Without conducting the second test, the operator or patient cannot verify the integrity of the dialyzer at the time of use.

Another known method for testing dialyzer integrity involves pumping a gas into the dialyzer. Leakage of the gas through the hollow fiber walls may then be measured. However, if the gas is unsanitary, the dialyzer may become contaminated and unusable.

Still another known method for testing dialyzer integrity involves wetting the dialyzer fibers before pumping a gas into the dialyzer. Leakage of the gas across the wet fiber walls may then be measured. Wetting the dialyzer is difficult to accomplish at a point of use and may contaminate a dialyzer.

Any of the previously mentioned tests may be performed with a higher pressure on the outside of the hollow fiber walls and a lower pressure on the inside of the hollow fibers so that the leak would be in the opposite direction.

A need, therefore, exists for a system and a method for determining integrity of a dialyzer. More specifically, a need exists for a system and a method for determining integrity of a dialyzer after transmitting dialysate toward the dialyzer.

### SUMMARY OF THE INVENTION

The present invention generally relates to a system and a method for determining integrity of a dialyzer. More specifically, the system involves measurement of an amount of a gas that may escape from a dialyzer after pressure is generated in a dispoable dialysis set by a transmittal of a liquid through the set toward the dialyzer.

To this end, in an embodiment of the present invention, a system is provided for determining integrity. The system has a dialyzer having an interior and further having hollow fibers within the interior wherein the hollow fibers have an interior and wherein the hollow fibers contain a gas and wherein the dialyzer has a leak threshold associated with the dialyzer wherein the leak threshold indicates an amount of the gas which may leak from the dialyzer which renders the dialyzer unfit for use. The system also has a first chamber connected to the dialyzer wherein the first chamber has an interior and further has a liquid within the interior of the first chamber. In addition, the system has a first transducer monitoring a pressure change within the dialyzer wherein the first transducer produces a signal indicating the pressure change. Further provided is a processor receiving the signal from the first transducer wherein the processor compares the pressure change within the dialyzer to the leak threshold associated with the dialyzer.

In an embodiment, the system has a second chamber connected to the dialyzer wherein the second chamber transfers a gas toward the dialyzer.

In an embodiment, the system has a pump connected to the first chamber.

In an embodiment, the dialyzer has a hollow fiber inlet port wherein the liquid within the first chamber is transmitted towards the hollow fiber inlet port.

In an embodiment, the dialyzer has an inlet dialysate port wherein the gas within the dialyzer exits the dialyzer through the inlet dialysate port.

In an embodiment, the liquid within the interior of the first chamber is dialysate.

In an embodiment, the gas within the hollow fibers is air.

In an embodiment, the system has a second transducer monitoring a pressure change within the dialyzer wherein the second transducer produces a signal indicating the pressure change.

In another embodiment of the present invention, a method is provided for determining integrity of a dialyzer having a gas within an interior of the dialyzer. The method comprises the steps of: connecting a first chamber holding a liquid to the dialyzer; creating a pressure gradient within the dialyzer; and monitoring a pressure decay within the dialyzer.

In an embodiment, the method comprises the step of transferring the liquid toward the dialyzer to create the pressure gradient.

In an embodiment, the method comprises the step of compressing the gas within the dialyzer.

In an embodiment, the method comprises the step of transferring the gas from the dialyzer to create the pressure decay.

In an embodiment, the method comprises the step of determining a mass flow rate for the gas within the dialyzer which exits the dialyzer.

In an embodiment, the method comprises the step of predetermining a leak threshold for the dialyzer wherein the leak threshold indicates an amount of the gas which may leak from the dialyzer which renders the dialyzer unfit for use.

In an embodiment, the method comprises the step of comparing the pressure decay to a leak threshold wherein the leak threshold indicates an amount of the gas which may leak from the dialyzer which renders the dialyzer unfit for use.

In another embodiment of the present invention, a method is provided for determining integrity of a dialyzer having an interior and further having air within the interior. The method comprises the steps of: transferring a liquid toward the dialyzer so that it compresses the air contained within the disposable set and within the dialyzer hollow fibers; stopping the transfer of fluid, measuring the pressure in the dialyzer, and calculating the pressure decay caused by the leakage removal of the air from the dialyzer.

In an embodiment, the method comprises the step of determining a mass flow rate for the air that is removed from the dialyzer.

In an embodiment, the method comprises the step of discontinuing the transfer of the liquid toward the dialyzer when the air is compressed.

In an embodiment, the method comprises the step of predetermining a leak threshold for the dialyzer wherein the leak threshold indicates an amount of the air which may leak from the dialyzer which renders the dialyzer unfit for use.

In an embodiment, the method comprises the step of comparing the pressure change to a leak threshold associated with the dialyzer wherein the leak threshold indicates an amount of the air which may leak from the dialyzer which renders the dialyzer unfit for use.

In another embodiment of the present invention, a system is provided for determining integrity. The system has a dialyzer having an interior and further having hollow fibers within the interior wherein the hollow fibers have an interior and wherein the hollow fibers contain a first gas and wherein the dialyzer has a leak threshold associated with the dialyzer wherein the leak threshold indicates an amount of the gas which may leak from the dialyzer which renders the dialyzer unfit for use. The system also has a liquid pump, a liquid supply and at least one fluid pathway connecting said liquid supply, said liquid pump and said dialyzer wherein said pathway initially contains a second gas. In addition, the system has at least one transducer monitoring a pressure within the hollow fibers wherein the transducer produces a signal indicating the pressure. The system also has a processor receiving the signal from the pressure transducer wherein the processor determines a rate of pressure change within the dialyzer and compares the rate of pressure change to the leak threshold associated with the dialyzer.

In an embodiment, the system has a second pressure transducer which monitors a pressure exterior to the hollow fibers and produces a signal indicating the pressure.

In an embodiment, the second gas contained in the liquid pathways is sterile.

In another embodiment of the present invention, a method is provided for determining integrity of a dialyzer having a gas within an interior of the dialyzer. The method comprises the steps of: connecting the dialyzer to a disposable set having an air separation chamber, a pump, a valve and a fluid delivery line which contains a gas; connecting a liquid supply to the disposable set; and creating a pressure within the disposable set and dialyzer by moving fluid from the liquid supply towards the dialyzer; stopping the movement of fluid towards the dialyzer; and monitoring a rate of pressure decay within the dialyzer.

In an embodiment, the disposable set performs peritoneal dialysis.

In an embodiment, the disposable set performs hemodialysis.

In an embodiment, the pump within the disposable set moves the fluid to generate the pressure.

It is, therefore, an advantage of the present invention to provide a system and a method for determining integrity of a dialyzer.

Another advantage of the present invention is to provide a system and a method for determining integrity of a dialyzer after transmittal of a liquid toward the dialyzer.

Yet another advantage of the present invention is to provide a system and a method for determining integrity of a dialyzer that reduces an amount of time required to detect a leak in the dialyzer.

In addition, it is an advantage of the present invention to provide a system and a method for determining integrity of a dialyzer that does not contaminate the dialyzer.

Moreover, an advantage of the present invention is to provide a system and a method for determining integrity of a dialyzer using a leak threshold to determine the integrity of the dialyzer.

Another advantage of the present invention is to provide a system and a method for determining integrity of a dialyzer which may not require human interaction.

A further advantage of the present invention is to provide a system and a method for determining integrity of a dialyzer that is cost efficient.

Additional features and advantages of the present invention are described in, and will be apparent from, the detailed description of the presently preferred embodiments and from the drawings.

### BRIEF DESCRIPTION OF THE DRAWINGS

FIG. 1 illustrates a block diagram of a system for determining integrity of a dialyzer in an embodiment of the present invention.

FIG. 2 illustrates a flowchart of a method for determining integrity of a dialyzer in an embodiment of the present invention.

FIG. 3 illustrates a block diagram of a system for determining integrity of a dialyzer in an embodiment of the present invention.

### DETAILED DESCRIPTION OF THE PRESENTLY PREFERRED EMBODIMENTS

The present invention generally relates to a system and a method for determining integrity of a dialyzer. More specifically, the integrity of the dialyzer may be determined after transmitting a liquid towards the dialyzer. An amount of a gas within the dialyzer and associated fluid pathways may be compressed by the transmittal of liquid towards the dialyzer. The gas may then escape from the dialyzer. The amount of gas that may escape may determine whether the dialyzer has a substantial leak wherein the dialyzer is unfit for use.

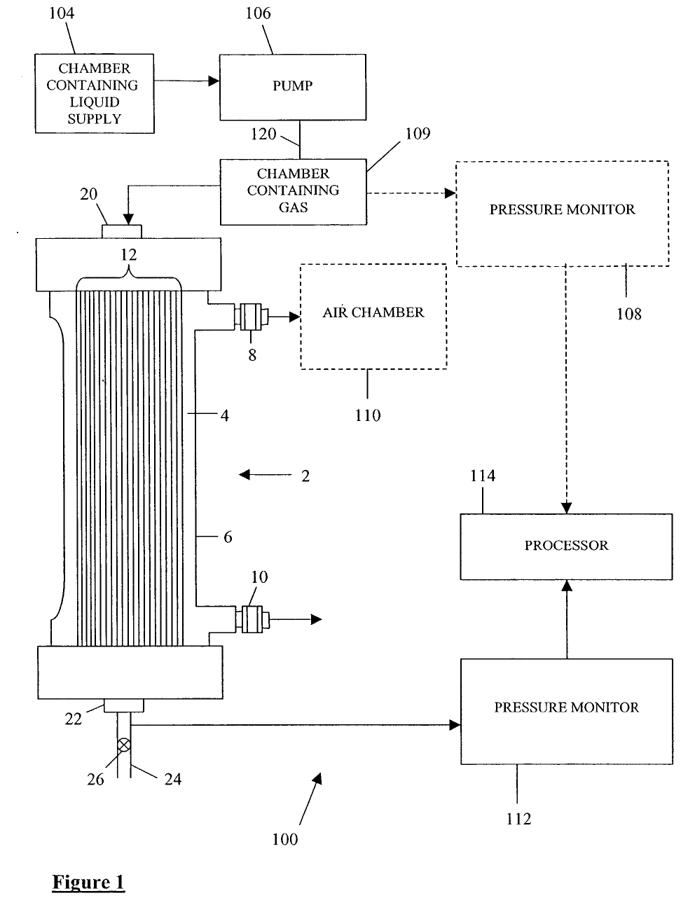

Referring now to the drawings, wherein like numerals refer to like parts, FIG. 1 illustrates a dialyzer 2 to be used in a disposable set or system 100 for determining integrity of the dialyzer 2. The dialyzer 2 may have an interior 4 and an exterior 6. In addition, the dialyzer 2 may have dialysate ports at the exterior 6 of the dialyzer 2. Preferably, the dialyzer 2 has two dialysate ports, an inlet dialysate port 8 and an outlet dialysate port 10. The dialyzer 2 may also have hollow fibers 12 within the interior 4 which may house a fluid such as, for example, blood, plasma, or the like. The hollow fibers 12 may also contain sterile gas, such as, for example, air. The hollow fibers 12 may prevent fluids, such as, for example, dialysate within the dialyzer 2 from contacting fluids within the hollow fibers 12. A fluid may be introduced within the hollow fibers 12 through a hollow fiber inlet port 20. The fluid may exit the dialyzer 2 through a hollow fiber outlet port 22.

Dialysate may be transferred into the dialyzer through the inlet dialysate port 8. The dialysate may travel toward the outlet dialysate port 10 and may be exterior to the hollow fibers 12. The fluid within the hollow fibers 12 may travel in a direction opposite a flow of the dialysate.

A tube 24 may be connected to the hollow fiber outlet port 22. The tube 24 may enable gas or other material within the hollow fibers 12 to be transmitted to, for example, a patient. A valve 26 may be provided adjacent to the tube 24. The valve 26 may prevent gas or other material within the dialyzer 2 from exiting the dialyzer 2 through the tube 24.

The dialyzer 2 may be connected to a chamber 104. A liquid, such as, for example, dialysate may be contained within the chamber 104. A pump 106 may be connected to the chamber 104. The pump 106 may withdraw fluid from the chamber 104 and direct for example, dialysate from the chamber 104 toward the dialyzer 2 through a tube 120 containing gas. A chamber 109 may be connected to the tube 120 and may also contain a gas. A flow of dialysate through the tube 120 may force the gas contained within the chamber 109 toward the dialyzer 2. The dialysate may remain within the tube 120 and may not enter the hollow fibers 12 of the dialyzer. When the pump 106 stops, the pressure in the hollow fibers 12 may remain constant, unless a leak exists.

A transducer, such as a pressure monitor 112, may be connected to the tube 24, preferably between the valve 26 and the hollow fiber outlet port 22. The pressure monitor 112 may measure a pressure change within the hollow fibers 12. The pressure change may be caused by compressed gas leaking from the hollow fibers 12 and exiting the dialyzer 2. The gas leaking from the hollow fibers 12 may exit from the dialyzer 2 through the inlet dialysate port 8 and/or the outlet dialysate port 10. The pressure change may be detected by the pressure monitor 112, and a signal indicative thereof may be sent to a processor 114.

The processor 114 may determine whether the dialyzer 2 has a substantial leak based on a pressure decay measured by the pressure monitor 112. A substantial leak may be defined as a leak which may render the dialyzer 2 unacceptable for use. The pressure change over time within the tube 24 may correlate to a mass flow rate of the gas exiting the dialyzer 2. The mass flow rate may be compared to a flow rate associated with a leak threshold for the dialyzer 2. If the mass flow rate of the gas exiting the dialyzer 2 is greater than the flow rate associated with the leak threshold, the dialyzer 2 may have a substantial leak.

For example, an air pressure of six psig may be generated within the hollow fibers 12 and the tube 24 by the pump 106. The pressure decay may then be monitored during a period of thirty seconds. A leak threshold of 0.036 psig may be predetermined for the dialyzer 2. If the pressure decay is greater than 0.036 psig during the thirty-second period, the dialyzer 2 may have a substantial leak.

In an alternate embodiment, a transducer or pressure monitor 108, shown in dashed lining, may be positioned at the chamber 109. The pressure monitor 108 may measure a pressure change within the dialyzer 2 caused by the gas leaking from the hollow fibers 12. The pressure monitor 108 may produce a signal indicative of the pressure change which may be sent to the processor 114. The processor may then determine whether the dialyzer 2 has a substantial leak.

In an alternate embodiment, an air chamber 110, shown in dashed lining, may be connected to the inlet dialysate port 8 of the dialyzer 2. Air within the hollow fibers 12 may be displaced, for example, when dialysate is pumped towards the dialyzer 2. The air may exit the dialyzer 2 through the inlet dialysate port 8 and enter the air chamber 110. The air within the dialyzer 2 may then be collected within the air chamber 110.

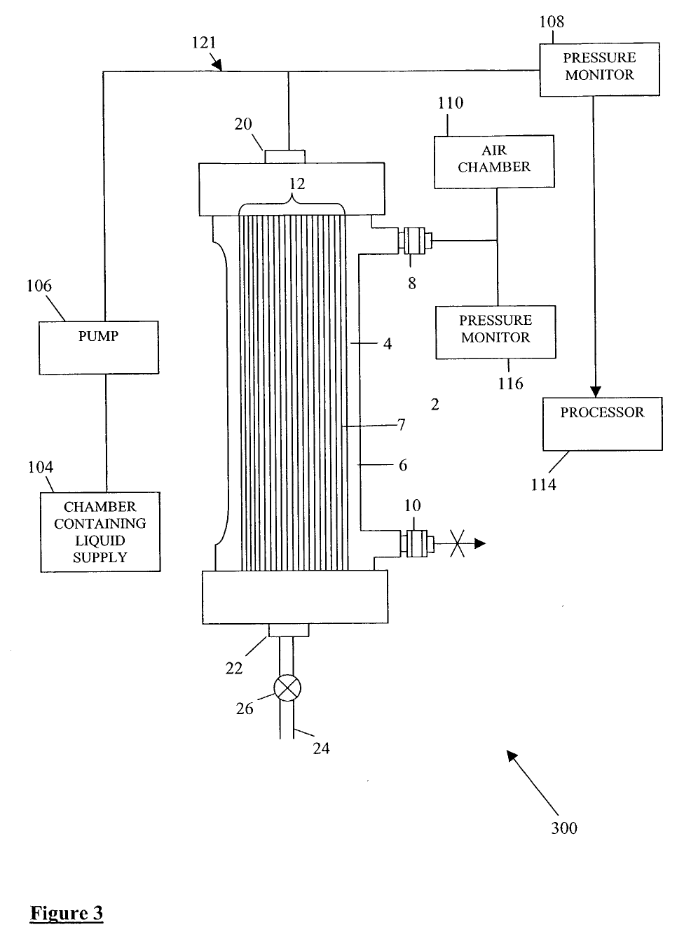

In an alternate system 300, illustrated in FIG. 3, the chamber 109 may be replaced by an air line 121 of sufficient volume to pressurize an interior 7 of the hollow fibers 12. Dialysate may be pumped from the chamber 104 by the pump 106 towards the dialyzer 2. The chamber 104 may contain dialysate for peritoneal dialysis. In an embodiment, the chamber 104 may contain a saline solution for hemodialysis blood line priming, or transmitting liquid into the hollow fibers 12. The air contained within the line 121 may be displaced and compressed by the dialysate. The air may then be pumped into the dialyzer 2. Pressure monitor 116 may be connected to the dialysate outlet port 8 in dialyzer 2. When pump 106 stops, a pressure inside the hollow fibers 12 may remain constant, unless a leak exists. Pressure monitor 116 may detect an increase in pressure in the dialyzer secondary (exterior to the hollow fibers 12) if a leak exists in the hollow fibers 12. Pressure monitor 108 may also detect a decrease in pressure. If pressure monitor 108 detects a decrease in pressure and pressure monitor 116 does not detect an increase in pressure, a loose connection may exist at one of the dialysate ports 8, 10. In this case, a leak may not exist in the hollow fibers 12 of the dialyzer 2.

In an alternate embodiment (not shown), the gas within the chamber 109 may be directed toward the inlet dialysate port 8. The outlet dialysate port 10 may be closed. If a leak exists within the hollow fibers 12, the gas directd into the inlet dialysate port 8 may enter into the interior 7 of the hollow fibers 12. The pressure monitor 116 may measure a pressure change exterior to the hollow fibers 12. The processor 114 may determine a flow rate of the gas entering into the interior 7 of the hollow fibers 12. The flow rate may be compared to a leak threshold for the dialyzer 2 to determine whether the dialyzer 2 is fit for use. The pressure monitor 108 may alternately measure a pressure change interior to the hollow fibers 12.

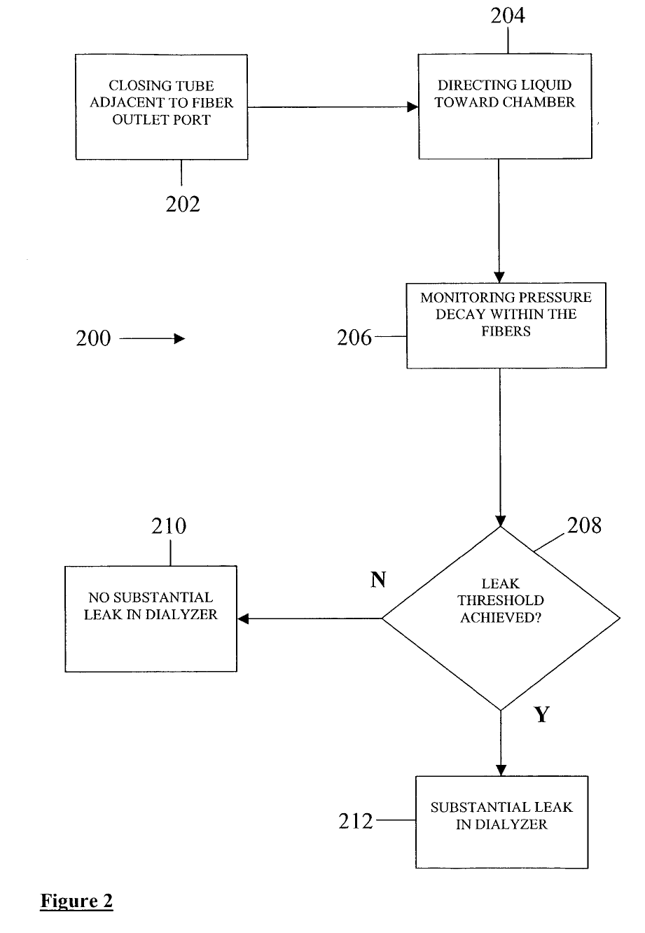

FIG. 2 illustrates a method 200 for determining integrity of the dialyzer 2. In a first step, shown at step 202, the tube 24 may be closed to prevent the gas within the hollow fibers 12 from exiting the hollow fiber outlet port 22. Next, liquid may be directed toward the chamber 109 by the pump 106, as shown at step 204.

The gas within the chamber 109 may be directed toward the dialyzer 2. In an embodiment, gas within the air line 121 may be directed toward the dialyzer 2. As a result, gas which may be contained within the dialyzer 2 may be compressed within the hollow fibers 12 of the dialyzer 2. Next, the pressure monitor 112 may measure a pressure decay within the hollow fibers 12, as shown at step 206. The processor 114 may then determine whether a leak threshold has been reached, as shown at step 208. If the measurements taken by the pressure monitor 112 or the pressure monitor 108 indicate that the mass flow rate of the gas is less than a flow rate associated with a threshold leak, the processor 114 may determine that a substantial leak does not exist within the dialyzer 2, as shown at step 210. However, if the measurements taken by the pressure monitor 108 and the pressure monitor 112 indicate that the threshold leak has been reached, the processor 114 may determine that a substantial leak exists within the dialyzer 2, as shown at step 212. The dialyzer 2 may then be repaired by, for example, sealing the hollow fibers 12 that are damaged. Alternatively, the dialyzer 2 may be considered unacceptable for use and may be replaced.

It should be understood that various changes and modifications to the presently preferred embodiments described herein will be apparent to those skilled in the art. Such changes and modifications may be made without departing from the spirit and scope of the present invention and without diminishing its attendant advantages. It is therefore intended that such changes and modifications be covered by the appended claims.

We claim:

1. A system for determining integrity, the system comprising:
a dialyzer having an interior and further having hollow fibers within the interior wherein the hollow fibers have an interior and wherein the hollow fibers contain a gas and wherein the dialyzer has a leak threshold associated with the dialyzer wherein the leak threshold indicates an amount of the gas which may leak from the dialyzer which renders the dialyzer unfit for use;
a first chamber connected to the dialyzer wherein the first chamber has an interior and further has a liquid within the interior of the first chamber;
a first transducer monitoring a pressure change within the dialyzer wherein the first transducer produces a signal indicating the pressure change; and
a processor receiving the signal from the first transducer wherein the processor compares the pressure change within the dialyzer to the leak threshold associated with the dialyzer.

2. The system of claim 1 further comprising:
a second chamber connected to the dialyzer wherein the second chamber transfers a gas toward the dialyzer.

3. The system of claim 1 further comprising:
a pump connected to the first chamber.

4. The system of claim 1 wherein the dialyzer has a hollow fiber inlet port wherein the liquid within the first chamber is transmitted towards the hollow fiber inlet port.

5. The system of claim 1 wherein the dialyzer has an inlet dialysate port wherein the gas within the dialyzer exits the dialyzer through the inlet dialysate port.

6. The system of claim 1 wherein the liquid within the interior of the first chamber is dialysate.

7. The system of claim 1 wherein the gas within the hollow fibers is air.

8. The system of claim 1 further comprising:
a second transducer monitoring a pressure change within the dialyzer wherein the second transducer produces a signal indicating the pressure change.

9. A method for determining integrity of a dialyzer having a gas within an interior of the dialyzer, the method comprising the steps of:
connecting a first chamber holding a liquid to the dialyzer;
creating a pressure gradient within the dialyzer; and
monitoring a pressure decay within the dialyzer.

10. The method of claim 9 further comprising the step of:
transferring the liquid toward the dialyzer to create the pressure gradient.

11. The method of claim 9 further comprising the step of:
compressing the gas within the dialyzer.

12. The method of claim 9 further comprising the step of:
transferring the gas from the dialyzer to create the pressure decay.

13. The method of claim 9 further comprising the step of:
determining a mass flow rate for the gas within the dialyzer which exits the dialyzer.

14. The method of claim 9 further comprising the step of:
predetermining a leak threshold for the dialyzer wherein the leak threshold indicates an amount of the gas which may leak from the dialyzer which renders the dialyzer unfit for use.

15. The method of claim 9 further comprising the step of:
comparing the pressure decay to a leak threshold wherein the leak threshold indicates an amount of the gas which may leak from the dialyzer which renders the dialyzer unfit for use.

16. A method for determining integrity of a dialyzer having an interior and further having air within the interior, the method comprising the steps of:
transferring a liquid toward the dialyzer to create a pressure gradient within the dialyzer;
compressing the air within the dialyzer;
allowing the air within the dialyzer to escape from the dialyzer to create a pressure change; and
measuring the pressure change caused by the air which escapes from the dialyzer.

17. The method of claim 16 further comprising the step of:
determining a mass flow rate for the air that is removed from the dialyzer.

18. The method of claim 16 further comprising the step of:
discontinuing the transfer of the liquid toward the dialyzer when the air is compressed.

19. The method of claim 16 further comprising the step of:
predetermining a leak threshold for the dialyzer wherein the leak threshold indicates an amount of the air which may leak from the dialyzer which renders the dialyzer unfit for use.

20. The method of claim 16 further comprising the step of: comparing the pressure change to a leak threshold associated with the dialyzer wherein the leak threshold indicates an amount of the air which may leak from the dialyzer which renders the dialyzer unfit for use.

21. A system for determining integrity, the system comprising:
a dialyzer having an interior and further having hollow fibers within the interior wherein the hollow fibers have an interior and wherein the hollow fibers contain a first gas and wherein the dialyzer has a leak threshold associated with the dialyzer wherein the leak threshold indicates an amount of the gas which may leak from the dialyzer which renders the dialyzer unfit for use;
a liquid pump;
a liquid supply;
at least one fluid pathway connecting said liquid supply, said liquid pump and said dialyzer wherein said pathway initially contains a second gas;
at least one transducer monitoring a pressure within the hollow fibers wherein the transducer produces a signal indicating the pressure; and
a processor receiving the signal from the pressure transducer wherein the processor determines a rate of pressure change within the dialyzer and compares the rate of pressure change to the leak threshold associated with the dialyzer.

22. The system of claim 21 further comprising:
a second pressure transducer which monitors a pressure exterior to the hollow fibers and produces a signal indicating the pressure.

23. The system of claim 21 wherein the second gas contained in the liquid pathways is sterile.

24. A method for determining the integrity of a dialyzer having a gas within an interior of the dialyzer, the method comprising the steps of:
connecting the dialyzer to a disposable set having an air separation chamber, a pump, a valve and a fluid delivery line which contains a gas;
connecting a liquid supply to the disposable set; and
creating a pressure within the disposable set and dialyzer by moving fluid from the liquid supply towards the dialyzer;
stopping the movement of fluid towards the dialyzer; and
monitoring a rate of pressure decay within the dialyzer.

25. The method of claim 24 wherein the disposable set performs peritoneal dialysis.

26. The method of claim 24 wherein the disposable set performs hemodialysis.

27. The method of claim 24 wherein the pump within the disposable set moves the fluid to generate the pressure.
